(19) United States
(12) Patent Application Publication
(10) Pub. No.: US 2025/0351130 A1
(43) Pub. Date: Nov. 13, 2025

(54) RESOURCE ALLOCATION METHOD, DEVICE, AND STORAGE MEDIUM

(71) Applicant: Beijing Xiaomi Mobile Software Co., Ltd., Beijing (CN)

(72) Inventors: Zhenyu ZHANG, Beijing (CN); Wei HONG, Beijing (CN); Yumin WU, Beijing (CN)

(21) Appl. No.: 18/869,355

(22) PCT Filed: May 27, 2022
(86) PCT No.: PCT/CN2022/095758

§ 371 Date: Nov. 26, 2024

(51) Int. Cl. H04W 72/0453; H04L 1/00; H04L 5/00

(52) U.S. Cl. CPC H04W 72/0453; H04L 1/0071; H04L 5/0094

(57) ABSTRACT

A resource allocation method in a communication system, includes: determining a resource allocation scheme, the resource allocation scheme being performing resource allocation based on a quintic permutation polynomial (5-PP) interleaver; allocating a frequency domain resource based on the resource allocation scheme; and sending frequency domain information, the frequency domain information being configured to determine the allocated frequency domain resource.

### CROSS-REFERENCE TO RELATED APPLICATIONS

The present application is a U.S. National Stage of International Application No. PCT/CN2022/095758 filed on May 27, 2022, the entire contents of which are incorporated herein by reference for all purposes.

### TECHNICAL FIELD

The present disclosure relates to the field of communication technology, and in particular, to a resource allocation method/device/apparatus in a communication system and a storage medium.

### BACKGROUND

An integrated sensing and communication (ISAC) system (i.e., a sensing and communication system, or a radar and communication (radcom) system) has been widely concerned in the next-generation wireless communication system in recent years. The sensing and communication can reduce the overall hardware cost of a communication system and a radar system, improve energy efficiency and spectrum efficiency, and alleviate the serious spectrum scarcity problem at this stage.

### SUMMARY

In a first aspect, an embodiment of the present disclosure provides a resource allocation method in a communication system, including:
determining a resource allocation scheme as performing resource allocation based on a 5-PP interleaver;
allocating a frequency domain resource based on the resource allocation scheme; and
sending frequency domain information, the frequency domain information being configured to determine an allocated frequency domain resource.

In a second aspect, an embodiment of the present disclosure provides a resource allocation device in a communication system, including: a processing module and a transceiver module,
the processing module is configured to determine a resource allocation scheme as performing resource allocation based on a quintic permutation polynomial (5-PP) interleaver;
the processing module is further configured to allocate a frequency domain resource based on the resource allocation scheme; and
the transceiver module is configured to send frequency domain information, the frequency domain information being configured to determine an allocated frequency domain resource.

In a third aspect, an embodiment of the present disclosure provides a communication device including a processor that performs the method described in the above first aspect when the processor calls a computer program in a memory.

In a fourth aspect, an embodiment of the present disclosure provides a communication device including a processor and a memory having a computer program stored thereon that, when being executed by the processor, causes the communication device to perform the method described in the above first aspect.

In a fifth aspect, an embodiment of the present disclosure provides a communication device including a processor and an interface circuit, the interface circuit is configured to receive code instructions and transmit the code instructions to the processor, and the processor is configured to run the code instructions to cause the device to perform the method described in the above first aspect.

In a sixth aspect, an embodiment of the present disclosure provides a communication system including the communication device described in the second aspect, or the communication device described in the third aspect, or the communication device described in the fourth aspect, or the communication device described in the fifth aspect.

In a seventh aspect, an embodiment of the present disclosure provides a computer-readable storage medium for storing instructions for use by the above network device that, when being executed, causes the terminal device to perform the method described in the above first aspect.

In an eighth aspect, the present disclosure further provides a computer program product including a computer program that, when runs on a computer, causes the computer to perform the method described in the above first aspect.

In a ninth aspect, the present disclosure provides a chip system including at least one processor and an interface to support a function of a network device involved in achieving the method described in the first aspect, for example, determining or processing at least one of data and information involved in the above method. In a possible design, the chip system further includes a memory for storing a necessary computer program and data of a source-auxiliary node. The chip system may consist of a chip or may include a chip and other discrete elements.

In a tenth aspect, the present disclosure provides a computer program that, when runs on a computer, causes the computer to perform the method described in the above first aspect.

### BRIEF DESCRIPTION OF THE DRAWINGS

The above and/or additional aspects and advantages of the present disclosure will become apparent and readily understood from the following description of embodiments in conjunction with the accompanying drawings, in which:

FIG. 1 is a schematic diagram of time-frequency domain resources of a sensing device-A to a sensing device-D under a consecutive subcarrier allocation scheme provided in an embodiment of the present disclosure;

FIG. 2 is a schematic diagram of time-frequency domain resources of a sensing device-A to a sensing device-D under a consecutive subcarrier allocation scheme provided in an embodiment of the present disclosure;

FIG. 3a is a stereo view of a radar image of the sensing device-A detecting another sensing device with the method illustrated in FIG. 1 provided in an embodiment of the present disclosure;

FIG. 3b is a plan view of a radar image of the sensing device-A detecting another sensing device with the method illustrated in FIG. 1 provided in an embodiment of the present disclosure;

FIG. 4a is a stereo view of a radar image of the sensing device-A detecting another sensing device with the method illustrated in FIG. 2 provided in an embodiment of the present disclosure;

FIG. 4b is a plan view of a radar image of the sensing device-A detecting another sensing device with the method illustrated in FIG. 2 provided in an embodiment of the present disclosure;

FIG. 5a is a schematic diagram of an architecture of a communication system provided in an embodiment of the present disclosure;

FIG. 5b is a flow diagram of a resource allocation method provided in an embodiment of the present disclosure;

FIG. 6a is a flow diagram of a resource allocation method provided in another embodiment of the present disclosure;

FIG. 6b is a flow diagram of a resource allocation method provided in yet another embodiment of the present disclosure;

FIG. 6c is a flow diagram of a resource allocation method provided in yet another embodiment of the present disclosure;

FIG. 7a is a flow diagram of a resource allocation method provided in yet another embodiment of the present disclosure;

FIG. 7b is a schematic diagram of time-frequency resources of the sensing device-A when a resource allocation is performed based on the method illustrated in FIG. 7a in an embodiment of the present disclosure;

FIGS. 7c and 7d are respectively a stereo view and a plan view of a radar detection for a sensing device with the method illustrated in FIG. 7a provided in an embodiment of the present disclosure;

FIG. 8a is a flow diagram of a resource allocation method in a communication system provided in yet another embodiment of the present disclosure;

FIG. 8b is a schematic diagram of time-frequency resources of the sensing device-A when a resource allocation is performed based on the method illustrated in FIG. 8a in an embodiment of the present disclosure;

FIGS. 8c and 8d are respectively a stereo view and a plan view of a radar detection for a sensing device with the method illustrated in FIG. 8a provided in an embodiment of the present disclosure;

FIG. 9 is a schematic diagram of a structure of a resource allocation device in a communication system provided in an embodiment of the present disclosure;

FIG. 10 is a block diagram of a user device provided in an embodiment of the present disclosure; and

FIG. 11 is a block diagram of a network side device provided in an embodiment of the present disclosure.

### DETAILED DESCRIPTION

Embodiments will be described herein in detail, examples of which are represented in the accompanying drawings. When the following description relates to the accompanying drawings, the same numerals in different accompanying drawings indicate the same or similar elements unless otherwise indicated. The implementations described in the following embodiments do not represent all implementations consistent with the embodiments of the present disclosure. Rather, they are only examples of devices and methods consistent with some aspects of embodiments of the present disclosure as detailed in the appended claims.

The term used in the embodiment of the present disclosure is used solely for the purpose of describing particular embodiments and is not intended to limit the embodiments of the present disclosure. The singular form of “a” and “the” used in the present disclosure and the appended claims is also intended to encompass the plural form, unless clearly indicated otherwise in the context. It is to be also understood that the term “and/or” as used herein refers to and encompasses any or all possible combinations of one or more of the associated listed items.

It is to be understood that while the terms first, second, third, etc. may be used in the embodiments of the present disclosure to describe various types of information, such information should not be limited to these terms. These terms are only used to distinguish the same type of information from one another. For example, without departing from the scope of the embodiments of the present disclosure, first information may also be referred to as second information, and similarly, the second information may be referred to as the first information. Depending on the context, the word “if” as used herein may be interpreted as “at the time of . . . ” or “when . . . ” or “in response to determining”.

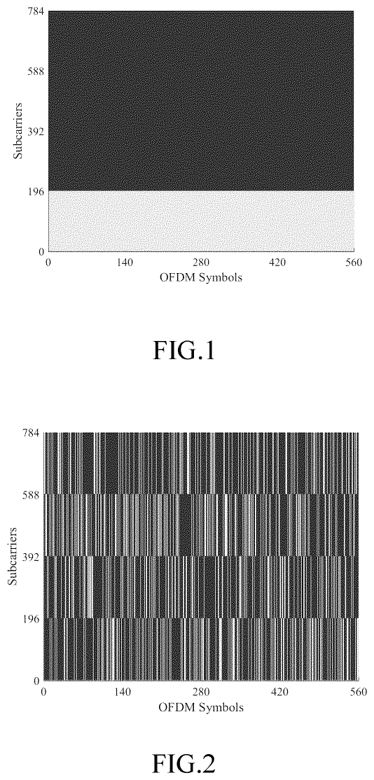

When a communication system and a radar system are converged, multi-user subcarrier allocation needs to be considered. In the related art, a consecutive subcarrier allocation scheme is usually used. Specifically, assuming that the total number of subcarriers corresponding to one frequency domain symbol is 784, and that there are four sensing devices in the communication system, which are respectively a sensing device-A, a sensing device-B, a sensing device-C, and a sensing device-D, the sensing device-A occupies the 1^{st}-196^{th} consecutive subcarriers, the sensing device-B occupies the 197^{th}-392^{nd} consecutive subcarriers, the sensing device-C occupies the 393^{rd} to 588^{th} consecutive subcarriers, and the sensing device-D occupies the 589^{th} to 784^{th} consecutive subcarriers. FIGS. 1 and 2 illustrate a schematic diagram of time-frequency domain resources of the sensing device-A to the sensing device-D under the consecutive subcarrier allocation scheme, wherein the black portion indicates subcarriers not occupied by the sensing device-A, and the white portion indicates subcarriers occupied by the sensing device-A. Further, with reference to FIGS. 1 and 2, there exist two schemes for the allocation of subcarriers in the time domain resource. For scheme 1, the positions of subcarriers in different time domain resources are fixed (i.e., the scheme illustrated in FIG. 1), and for the scheme 2, the positions of subcarriers in different time domain resources varies randomly (i.e., the scheme illustrated in FIG. 2).

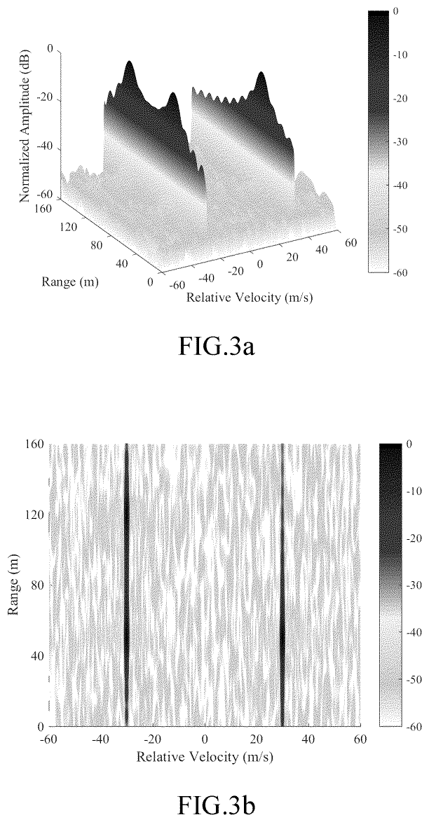

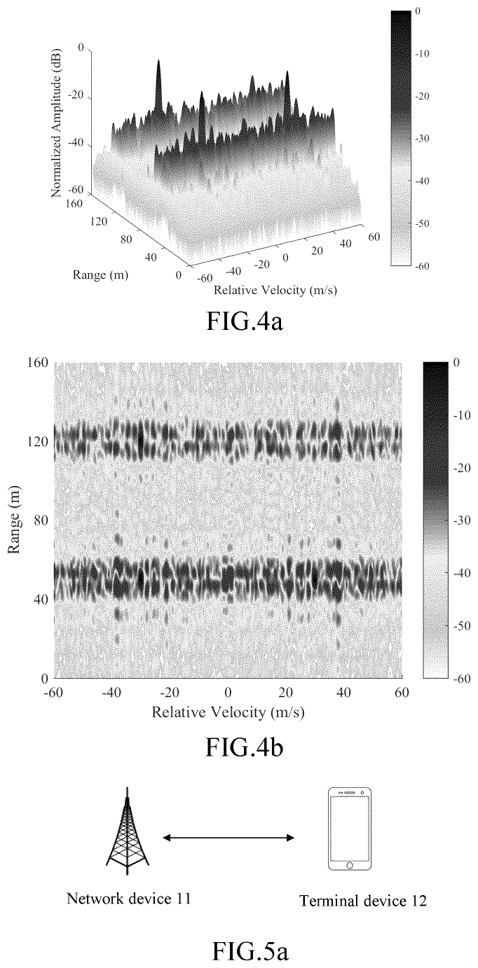

However, the resource allocation method in the related art will make a signal correlation between subcarriers of a sensing device relatively large, which in turn makes a sensing device not able to accurately detect a range and velocity of another sensing device. For example, assuming that a modulation manner is the Quadrature Phase Shift Keying (QPSK), and the Signal to Noise Ratio (SNR) is set to 0 dB, FIGS. 3a and 3b respectively illustrate a stereo view and a plan view of a radar image of the sensing device-A detecting another sensing device with the method illustrated in FIG. 1, and FIGS. 4a and 4b respectively illustrate a stereo view and a plan view of an radar image of the sensing device-A detecting another sensing device under the method illustrated in FIG. 2. As illustrated in FIGS. 3a and 3b, when the scheme 1 is used to allocate resources for the sensing device, range expansion occurs on the range axis (i.e., the vertical axis), and as illustrated in FIGS. 4a and 4b, when the scheme 2 is used to allocate resources for the sensing device, not only velocity expansion occurs on the velocity axis (i.e., the horizontal axis), but also there is a high sub-peak and many side lobes, so that the detection effect is unsatisfactory, and it is not possible to accurately detect the range and velocity of the UE.

In order to better understand a resource allocation method in a communication system disclosed by embodiments of the present disclosure, a communication system to which the embodiments of the present disclosure are applied is first described below.

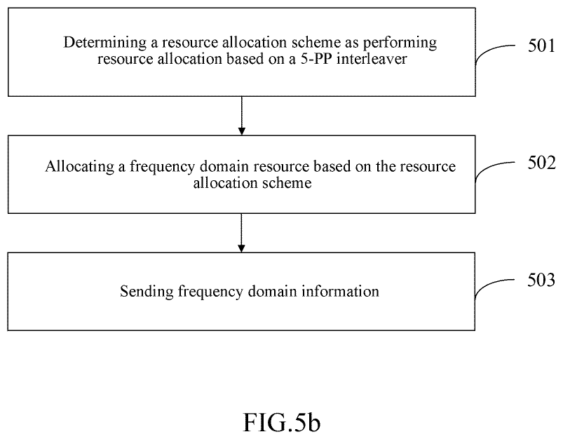

Referring to FIG. 5a, which is a schematic diagram of an architecture of a communication system provided in an embodiment of the present disclosure, the communication system may include, but is not limited to, one network device and one terminal device, the number and form of the devices illustrated in FIG. 5a are illustrative only and do not constitute a limitation on the embodiments of the present disclosure, and in practical applications, two or more network devices and two or more terminal devices may be included. The communication system illustrated in FIG. 5a is illustrated as an example of a communication system including one network device 11 and one terminal device 12.

It is to be noted that the technical solution of the embodiments of the present disclosure can be applied to various communication systems, for example, a long-term evolution (LTE) system, a 5^{th} generation (5G) mobile communication system, a 5G new radio (NR) system, or other new future mobile communication systems.

The network device 11 in an embodiment of the present disclosure is an entity on the network side for transmitting or receiving signals. For example, the network device 11 may be an evolved NodeB (eNB), a transmission reception point (TRP), a next generation NodeB (gNB) in an NR system, a base station in other future mobile communication systems, or an access node in a wireless fidelity (WiFi) system, and the like. The specific technologies and specific device forms used in the network device are not limited in the embodiments of the present disclosure. The network device provided by the embodiments of the present disclosure may consist of a central unit (CU) and a distributed unit (DU). The CU may also be called a control unit, and the structure of the CU-DU may split the protocol layer of the network device such as a base station, in which some functions of the protocol layer are placed in the CU to be controlled centrally, and the remaining or all the functions of the protocol layer are distributed in the DU to be controlled by the CU centrally.

The terminal device 12 in the embodiments of the present disclosure is an entity on the user side for receiving or transmitting signals, for example, a mobile phone. The terminal device may also be referred to as a terminal, a user equipment (UE), a mobile station (MS), a mobile terminal (MT), or the like. The terminal device can be a car with a communication function, an intelligent car, a mobile phone, a wearable device, a tablet computer (Pad), a computer with a wireless transceiver function, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transport safety, a wireless terminal device in smart city, a wireless terminal device in smart home, and so on. The specific technologies and specific device forms used for the terminal device are not specifically limited in the embodiments of the present disclosure.

It is to be understood that the communication system described in the embodiments of the present disclosure is intended to more clearly illustrate the technical solution of the embodiments of the present disclosure, and does not constitute a limitation of the technical solution provided by the embodiments of the present disclosure, and a person skilled in the art may know that, with the evolution of the system architecture and the emergence of new service scenarios, the technical solution provided by the embodiments of the present disclosure is equally applicable to similar technical problems.

Embodiments of the present disclosure are described in detail below, and examples of the embodiments are illustrated in the accompanying drawings, throughout which the same or similar reference numerals indicate the same or similar elements. The embodiments described below with reference to the accompanying drawings are exemplary and are intended to explain the present disclosure instead of being construed as a limitation of the present disclosure.

A sensing device involved in the present disclosure may refer to a user device having a sensing capability, i.e., it may have the capability of actively sensing and/or passively sensing. With the assistance of radar, a communication system can achieve more accurate and efficient mutual sensing between sensing devices.

FIG. 5b is a flow diagram of a resource allocation method in a communication system provided in an embodiment of the present disclosure. As illustrated in FIG. 5b, the resource allocation method may include the following steps.

In step 501, a resource allocation scheme is determined as performing resource allocation based on a quintic permutation polynomial (5-PP) interleaver.

In an embodiment of the present disclosure, the method may be applicable to a self-organizing network, which may include a plurality of sensing devices, and the plurality of sensing devices may sense and detect each other. The sensing device may be a user equipment (UE).

It is to be noted that in an embodiment of the present disclosure, the UE may be a device that provides voice and/or data connectivity to a user. The terminal device may communicate with one or more core networks via a Radio Access Network (RAN), and the UE may be an IoT terminal, such as a sensor device, a mobile phone (or “cellular” phone), and a computer with an IoT terminal, which may be, for example, fixed, portable, pocket-sized, handheld, computer-integrated, or vehicle-mounted device, for example, a station (STA), a subscriber unit, a subscriber station, a mobile station, a mobile, a remote station, an access point, a remote terminal, an access terminal, a user terminal, or user agent. Alternatively, the UE may be an unmanned aerial vehicle device. Alternatively, the UE may be an in-vehicle device, e.g., it may be a trip computer with a wireless communication capability, or a wireless terminal externally connected to a trip computer. Alternatively, the UE may be a roadside device, e.g., it may be a street light, a signal light, or other roadside device having a wireless communication capability.

Further, in an embodiment of the present disclosure, determining the resource allocation scheme as described above may include at least one of the following.

In method a, the resource allocation scheme is determined based on a protocol agreement.

Specifically, in an embodiment of the present disclosure, determining the resource allocation scheme based on the protocol agreement may include at least one of:
determining a plurality of alternative resource allocation schemes based on the protocol agreement, and determining, on its own, the resource allocation scheme among the plurality of alternative resource allocation schemes; and
determining the resource allocation scheme directly based on the protocol agreement (i.e. the protocol agreement only agrees on one resource allocation scheme).

In method b, the resource allocation scheme is determined on its own.

In method c, the resource allocation scheme is determined based on a configuration from a base station.

Specifically, in an embodiment of the present disclosure, determining the resource allocation scheme based on the configuration from the base station may include at least one of the followings.

The resource allocation scheme configured by the base station via semi-static signaling is obtained, in which the semi-static signaling may be Ratio Resource Control (RRC) signaling.

The resource allocation scheme configured by the base station and a time-frequency domain resource associated with the resource allocation scheme are obtained, and a corresponding resource allocation scheme is determined based on the currently used time-frequency domain resource, in which the resource allocation scheme and the time-frequency domain resource associated with the resource allocation scheme may be configured via the same signaling or via different signaling respectively. Further, for example, assuming that the time-frequency domain resource associated with the “resource allocation scheme: performing the resource allocation based on the 5-PP interleaver” configured by the base station is a carrier frequency of 24 GHz, and if the carrier frequency of the time-domain resource currently used is 24 GHz, it may determine the resource allocation scheme correspondingly as performing the resource allocation based on the 5-PP interleaver.

The resource allocation scheme configured by the base station via dynamic signaling is obtained. Specifically, in an embodiment of the present disclosure, the base station may configure a plurality of alternative resource allocation schemes via RRC signaling, and then dynamically configure via dynamic signaling which resource allocation scheme among the plurality of alternative resource allocation schemes is to be used for resource allocation. The dynamic signaling may be Downlink Control Information (DCI) signaling and/or Media Access Control-Control Element (MAC-CE) signaling.

A plurality of alternative resource allocation schemes configured by the base station are obtained, and the resource allocation scheme is determined on its own among the plurality of alternative resource allocation schemes.

In method d, the resource allocation scheme is determined based on a configuration from a core network device.

Specifically, in an embodiment of the present disclosure, determining the resource allocation scheme based on the configuration from the core network device may include at least one of:
obtaining the resource allocation scheme configured by the core network device via semi-static signaling;
obtaining the resource allocation scheme configured by the core network device and a time-frequency domain resource associated with the resource allocation scheme, and determining a corresponding resource allocation scheme based on a currently used time-frequency domain resource; and
obtaining the resource allocation scheme configured by the core network device via dynamic signaling.
obtaining a plurality of alternative resource allocation schemes configured by the core network device, and determining the resource allocation scheme on its own among the plurality of alternative resource allocation schemes.

The method of configuring the resource allocation scheme by the core network device is analogous to the method of configuring the resource allocation scheme by the base station described above, which will not be repeated herein.

In step 502, a frequency domain resource is allocated based on the resource allocation scheme.

In an embodiment of the present disclosure, the resource allocation may be specifically performed based on the 5-PP interleaver. Further, details as how to perform the frequency domain resource allocation based on the 5-PP interleaver will be described in detail in the following embodiments.

In step 503, frequency domain information is sent.

In an embodiment of the present disclosure, the frequency domain information may be used to determine an allocated frequency domain resource. Specifically, the frequency domain information may include the frequency domain resource of each sensing device.

In view of the above, in the resource allocation method in the communication system provided in the embodiment of the present disclosure, the resource allocation scheme is first determined as performing the resource allocation based on the 5-PP interleaver, then the frequency domain resource is allocated based on the resource allocation scheme, and then the frequency domain information is sent, in which the frequency domain information is configured to determine the allocated frequency domain resource. As can be seen, in the embodiment of the present disclosure, the 5-PP interleaver is introduced to allocate resource for the sensing device, which avoids the allocation of consecutive subcarriers for the sensing device, reduces the correlation between the subcarriers of the sensing device, optimizes the frequency domain resource of the sensing and communication system, and thus improves the sensing detection resolution and performance of the sensing and communication system.

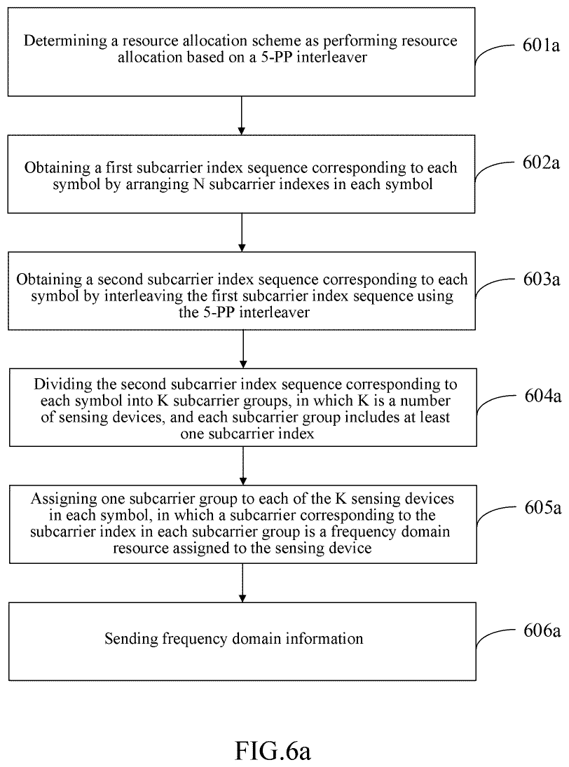

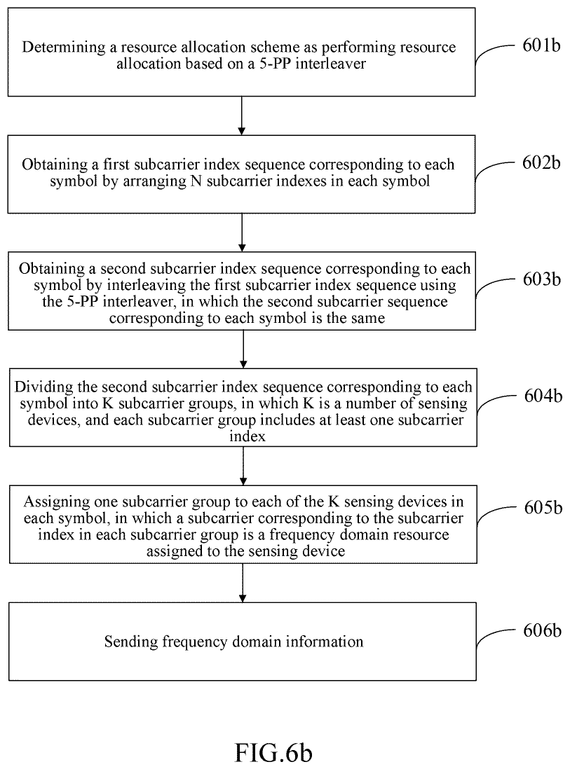

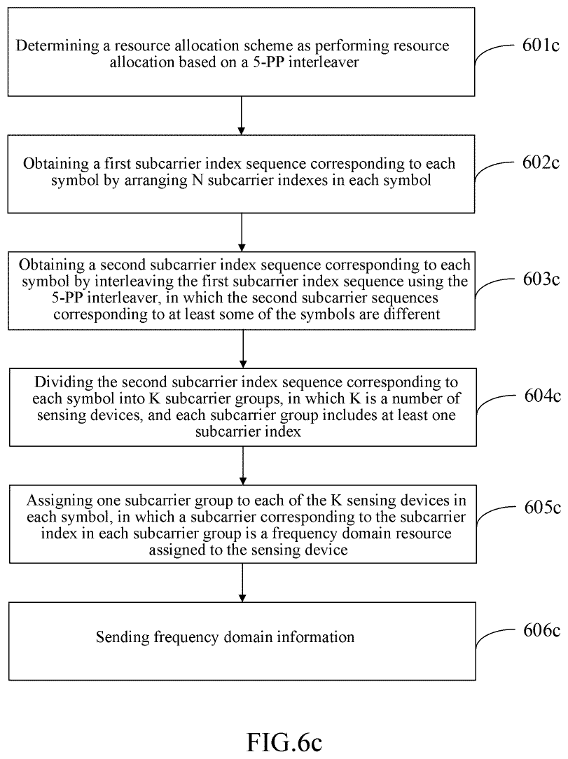

FIG. 6a is a flow diagram of a resource allocation method in a communication system provided in an embodiment of the present disclosure, as illustrated in FIG. 6a, the resource allocation method may include the following steps.

In step 601a, a resource allocation scheme is determined as performing resource allocation based on a 5-PP interleaver.

In step 602a, a first subcarrier index sequence corresponding to each symbol is obtained by arranging N subcarrier indexes in each symbol.

In an embodiment of the present disclosure, the symbol may be an Orthogonal Frequency Division Multiplexing (OFDM) symbol.

Further, in an embodiment of the present disclosure, the first subcarrier index sequence may be configured in such a way that subcarrier indexes are arranged in an order from the smallest to the largest, or from the largest to the smallest. For example, when the number of subcarriers is N, the first subcarrier index sequence corresponding to the symbol may be: (0, 1, 2, . . . , N−1) or (N−1, N−2, N−3, . . . , 1, 0).

In step 603a, a second subcarrier index sequence corresponding to each symbol is obtained by interleaving the first subcarrier index sequence using the 5-PP interleaver.

In an embodiment of the present disclosure, obtaining the second subcarrier index sequence corresponding to each symbol by interleaving may mainly include the following steps.

In step 1, parameter information of the 5-PP interleaver is determined.

In an embodiment of the present disclosure, the parameter information of the 5-PP interleaver includes at least one of:
a 5-PP interleaver algebraic polynomial;
a decomposition formula corresponding to the 5-PP interleaver; and
a parameter value-determining rule in the 5-PP interleaver algebraic polynomial.

Specifically, in an embodiment of the present disclosure, the 5-PP interleaver algebraic polynomial is:

$$π ( i ) = ( {f}_{1} \cdot i + {f}_{2} \cdot {i}^{2} + {f}_{3} \cdot {i}^{3} + {f}_{4} \cdot {i}^{4} + {f}_{5} \cdot {i}^{5} ) mod N \qquad ( 1 )$$

in which i is configured to indicate an i^{th} index in the second subcarrier index sequence, π(i) is a value of the i^{th} index in the second subcarrier index sequence, f₁, f₂, f₃, f₄ and f₅ are five interleaving parameters of the 5-PP interleaver, and the parameter value-determining rule is configured to determine values of the interleaving parameters f₁, f₂, f₃, f₄ and f₅.

In an embodiment of the present disclosure, the decomposition formula corresponding to the 5-PP interleaver is:

$$N = {\prod }_{i = 1}^{ω ( N )} {p}_{i}^{{α}_{N , i}} \qquad ( 2 )$$

in which ω(N) is a positive integer, pᵢ is a factor of N, and α_{N,i} is a corresponding exponent.

Further, in an embodiment of the present disclosure, the parameter value-determining rule is:

| | | |
|---|---|---|
| P₁ = 2 | α_{N, 1} = 1 | (f₁ + f₂ + f₃ + f₄ + f₅) = 1 mod 2 |
| | α_{N, 1} > 1 | f₁ = 1 mod 2, (f₂ + f₄) = 0 mod 2, |
| | | (f₃ + f₅) = 0 mod 2 |
| P₂ = 3 | α_{N, 2} = 1 | (f₁ + f₃ + f₅) ≠ 0 mod 3, (f₂ + f₄) = 0 mod 3 |
| | α_{N, 2} > 1 | f₁ ≠ 0 mod 3, (f₁ + f₃ + f₅) ≠ 0 mod 3, |
| | | (f₂ + f₄) = 0 mod 3, |
| | | (f₁ + f₂ + 2f₅) ≠ 0 mod 3, (f₁ + f₄ + 2f₅) ≠ 0 mod 3 |

As illustrated in the table above, the parameter value-determining rule may specifically be that:

when pᵢ=2 and α_{N,1}=1, the interleaving parameter satisfies the condition the condition (f₁+f₂+f₃+f₄+f₅)=1 mod 2; and

when pᵢ=2 and α_{N,1}>1, the interleaving parameter satisfies the condition f₁=1 mod 2, (f₂+f₄)=0 mod 2, (f₃+f₅)=0 mod 2.

Further, in an embodiment of the present disclosure, determining the parameter information of the 5-PP interleaver described above may include at least one of:
obtaining the parameter information of the 5-PP interleaver sent by a base station, in which the parameter information of the 5-PP interleaver is pre-configured to the base station by a core network device;
obtaining the parameter information of the 5-PP interleaver sent by the base station, in which the parameter information of the 5-PP interleaver is pre-configured to the base station by another base station;
obtaining the parameter information of the 5-PP interleaver sent by a network device (a base station and/or a core network device); and
determining the parameter information of the 5-PP interleaver based on a protocol agreement.

In step 2, values of pᵢ and α_{N,i} are determined by decomposing the N based on the decomposition formula.

For example, in an embodiment of the present disclosure, assuming that N is 10, N may be decomposed into 2¹×5=10 based on the decomposition formula, and it may obtain pᵢ=2 and 5, and α_{N,i}=1.

In step 3, the values of the interleaving parameters f₁, f₂, f₃, f₄ and f₅ are determined based on the values of pᵢ and α_{N,i} and the parameter value-determining rule.

In an embodiment of the present disclosure, the condition to be satisfied by the corresponding interleaving parameters may be determined based on the values of pᵢ and α_{N,i} determined in step 2, and then the values of the interleaving parameters f₁, f₂, f₃, f₄ and f₅ may be obtained based on the condition to be satisfied by the interleaving parameters.

For example, in an embodiment of the present disclosure, it is assumed that it is determined based on the parameter value-determining rule that the interleaving parameters are f₁=199, f₂=7, f₃=560, f₄=777 and f₅=28.

In step 4, the second subcarrier index sequence corresponding to each symbol is calculated by taking the interleaving parameters into the 5-PP interleaver algebraic polynomial.

Specifically, in an embodiment of the present disclosure, the second subcarrier index sequence may be calculated by taking the values of the interleaving parameters f₁, f₂, f₃, f₄ and f₅ into the 5-PP interleaver algebraic polynomial.

For example, assuming that the first subcarrier index sequence is (0, 1, 2, 3, 4, 5, 6, 7, 8, 9), the second subcarrier index sequence may be calculated as (1, 4, 8, 3, 5, 6, 9, 2, 7, 0) by taking the corresponding interleaving parameters into the 5-PP interleaver algebraic polynomial.

In step 604a, the second subcarrier index sequence corresponding to each symbol is divided into K subcarrier groups, in which K is a number of sensing devices and is a positive integer, and each subcarrier group includes at least one subcarrier index.

In an embodiment of the present disclosure, the K subcarrier groups may be divided based on the following manner:
in response to that N is divisible by K, a number of subcarrier indexes in each of the K subcarrier groups is the same; and
in response to that N is not divisible by K, a number of subcarrier indexes in each of d subcarrier groups among the K subcarrier groups is the same, a number of subcarrier indexes in each of other subcarrier groups than the d subcarrier groups among the K subcarrier groups is the same, and the number of subcarrier indexes in each of the d subcarrier groups is 1 more than the number of subcarrier indexes in each of the other subcarrier groups, where d is a value obtained by N mod K.

For example, in an embodiment of the present disclosure, assuming that N is 10 and K is 2, N is divisible by K, and the interleaved subcarrier index sequence may then be divided into 2 subcarrier groups, and the number of subcarrier indexes in each of the 2 subcarrier groups is the same, e.g., may be 5.

For example, the second subcarrier index is (1, 4, 8, 3, 5, 6, 9, 2, 7, 0), and according to that order, the first five indexes in the second subcarrier index sequence may be divided into subcarrier group #1 (1, 4, 8, 3, 5), and the last five indexes in the second subcarrier index sequence are divided into subcarrier group #2 (6, 9, 2, 7, 0).

For example, in another embodiment of the present disclosure, assuming that N is 10 and K is 3, N is not divisible by K, and the value of d obtained by N mod K is 1. At this time, the interleaved subcarrier index sequence can be divided into 3 subcarrier groups, there exist 2 subcarrier groups among the 3 subcarrier groups each having the same number of subcarrier indexes, the number of subcarrier indexes in the remaining 1 subcarrier group among the 3 subcarrier groups is different from that in the above 2 subcarrier groups, and the number of subcarrier indexes in the remaining 1 subcarrier group is 1 more than the number of subcarrier indexes in the above 2 subcarrier groups.

For example, the second subcarrier index may be (1, 4, 8, 3, 5, 6, 9, 2, 7, 0) as described above, and according to that order, the first four subcarrier indexes in the second subcarrier index sequence may be divided into subcarrier group #1 (1, 4, 8, 3), the fifth to seventh subcarrier indexes in the second subcarrier index sequence may be divided into subcarrier group #2 ((5, 6, 9), and the last three subcarrier indexes in the second subcarrier index sequence may be divided into subcarrier group #2 (2, 7, 0). Alternatively, the first three and the last subcarrier indexes in the second subcarrier index sequence may be divided into subcarrier group #1 (1, 4, 8, 0), the fourth to sixth subcarrier indexes in the second subcarrier index sequence are divided into subcarrier group #2 (3, 5, 6), and the seventh to ninth subcarrier indexes in the second subcarrier index sequence are divided into subcarrier group #3 (9, 2, 7). That is, in an embodiment of the present disclosure, the subcarrier indexes in the interleaved subcarrier index sequence may be divided in a sequential order to obtain subcarrier groups, or may be divided not in the sequential order to obtain subcarrier groups.

In step 605a, one subcarrier group is assigned to each of the K sensing devices in each symbol, in which a subcarrier corresponding to the subcarrier index in each subcarrier group is a frequency domain resource assigned to the sensing device.

In an embodiment of the present disclosure, a Kth subcarrier group may be assigned to a Kth sensing device. For example, assuming that there are two sensing devices in the sensing and communication system, which respectively are a sensing device-A and a sensing device-B, and that the obtained K subcarrier groups are subcarrier group #1 and subcarrier group #2, the subcarrier group #1 may be assigned to the sensing device-A, and the subcarrier group #2 may be assigned to the sensing device-B. At this time, the subcarriers corresponding to the subcarrier indexes in the subcarrier group #1 may be the frequency domain resources assigned to the sensing device-A (e.g., when the subcarrier group #1 is (1, 4, 8, 3, 5), the subcarriers with the subcarrier indexes 1, 4, 8, 3, 5 in the symbol can be determined as the frequency domain resources of the sensing device-A), and the subcarriers corresponding to the subcarrier indexes in the subcarrier group #2 may be the frequency domain resources assigned to the sensing device-B (e.g., when the subcarrier group #2 is (6, 9, 2, 7, 0), the subcarriers with the subcarrier indexes 6, 9, 2, 7, 0 in the symbol can be determined as the frequency domain resources of the sensing device-B).

It is to be noted that, as can be seen from the above steps 602a and 603a, in the embodiment of the present disclosure, the 5-PP interleaver is used to interleave the sequentially arranged first subcarrier index sequence, and thus the second subcarrier index sequence can be obtained. Moreover, the subcarrier indexes in the second subcarrier index sequence are arranged in a disordered order. Then, the second subcarrier index sequence is grouped to obtain subcarrier groups by performing steps 604a and 605a, and the subcarrier group is assigned to the sensing device. Since the subcarrier indexes in the second subcarrier index sequence are arranged in a disordered order, the subcarrier indexes in the subcarrier group obtained by grouping are also arranged in a disordered order, so that the subcarrier indexes of the subcarriers assigned to each sensing device are also arranged in a disordered order (i.e., arranged in a non-consecutive order), and thus when the sensing device subsequently communicate based on the non-consecutive subcarriers, signal correlation between the respective subcarriers of the sensing device can be reduced, which ensures the detection effect of the sensing device.

In step 606a, frequency domain information is sent.

In an embodiment of the present disclosure, the frequency domain information may indicate the frequency domain resource allocated for each sensing device.

For example, in an embodiment of the present disclosure, based on the above step 605a, the frequency domain information may indicate that the frequency domain resource of the sensing device-A is the subcarrier group #1, and the frequency domain resource of the sensing device-B is the subcarrier group #2.

In view of the above, in the resource allocation method in the communication system provided in the embodiment of the present disclosure, the resource allocation scheme is first determined as performing the resource allocation based on the 5-PP interleaver, then the frequency domain resource is allocated based on the resource allocation scheme, and then the frequency domain information is sent, in which the frequency domain information is configured to determine the allocated frequency domain resource. As can be seen, in the embodiment of the present disclosure, the 5-PP interleaver is introduced to allocate resource for the sensing device, which avoids the allocation of consecutive subcarriers for the sensing device, reduces the correlation between the subcarriers of the sensing device, optimizes the frequency domain resource of the sensing and communication system, and thus improves the sensing detection resolution and performance of the sensing and communication system.

FIG. 6b illustrates a flow diagram of a resource allocation method in a communication system provided in an embodiment of the present disclosure. As illustrated in FIG. 6b, the resource allocation method may include the following steps.

In step 601b, a resource allocation scheme is determined as performing resource allocation based on a 5-PP interleaver.

In step 602b, a first subcarrier index sequence corresponding to each symbol is obtained by arranging N subcarrier indexes in each symbol.

In an embodiment of the present disclosure, the N subcarrier indexes in each symbol may be arranged in an order from the smallest to the largest such that the first subcarrier index sequences corresponding to respective symbols are the same, all of which are (0, 1, 2, . . . , N−1).

In step 603b, a second subcarrier index sequence corresponding to each symbol is obtained by interleaving the first subcarrier index sequence using the 5-PP interleaver, in which the second subcarrier sequence corresponding to each symbol is the same.

It can be seen from the above that in an embodiment of the present disclosure, the second subcarrier sequence corresponding to each symbol is calculated based on the interleaving parameters f₁, f₂, f₃, f₄ and f₅, and thus whether the second subcarrier sequences corresponding to different symbols are the same or not is mainly related to whether the interleaving parameters used in calculating the second subcarrier sequences in different symbols are the same or not. When the interleaving parameters used in calculating the second subcarrier sequences in different symbols are different, the second subcarrier sequences corresponding to different symbols may be different, and when the interleaving parameters used in calculating the second subcarrier sequences in different symbols are the same, the second subcarrier sequences corresponding to the different symbols are the same.

Further, in the embodiment, only one group of interleaving parameters may be determined, and the second subcarrier sequence is calculated for each symbol by using this group of interleaving parameters, so that respective symbols may correspond to the same second subcarrier sequence.

For example, assuming that the interleaving parameters determined in this step are f₁=199, f₂=7, f₃=560, f₄=777 and f₅=28, the second subcarrier sequence corresponding to each symbol may be calculated using the interleaving parameters f₁=199, f₂=7, f₃=560, f₄=777 and f₅=28.

In step 604b, the second subcarrier index sequence corresponding to each symbol is divided into K subcarrier groups, in which K is a number of sensing devices and is a positive integer, and each subcarrier group includes at least one subcarrier index.

In Step 605b, one subcarrier group is assigned to each of the K sensing devices in each symbol, in which a subcarrier corresponding to the subcarrier index in each subcarrier group is a frequency domain resource assigned to the sensing device.

In step 606b, frequency domain information is sent.

Other details about steps 601b-606b can refer to the above description of the embodiments, which will not be repeated herein in the embodiment of the present disclosure.

In view of the above, in the resource allocation method in the communication system provided in the embodiment of the present disclosure, the resource allocation scheme is first determined as performing the resource allocation based on the 5-PP interleaver, then the frequency domain resource is allocated based on the resource allocation scheme, and then the frequency domain information is sent, in which the frequency domain information is configured to determine the allocated frequency domain resource. As can be seen, in the embodiment of the present disclosure, the 5-PP interleaver is introduced to allocate resource for the sensing device, which avoids the allocation of consecutive subcarriers for the sensing device, reduces the correlation between the subcarriers of the sensing device, optimizes the frequency domain resource of the sensing and communication system, and thus improves the sensing detection resolution and performance of the sensing and communication system.

FIG. 6c illustrates a flow diagram of a resource allocation method in a communication system provided in an embodiment of the present disclosure. As illustrated in FIG. 6c, the resource allocation method may include the following steps.

In step 601c, a resource allocation scheme is determined as performing resource allocation based on a 5-PP interleaver.

In step 602c, a first subcarrier index sequence corresponding to each symbol is obtained by arranging N subcarrier indexes in each symbol.

In step 603c, a second subcarrier index sequence corresponding to each symbol is obtained by interleaving the first subcarrier index sequence using the 5-PP interleaver, in which the second subcarrier sequences corresponding to at least some of the symbols are different.

It can be seen from the above that in an embodiment of the present disclosure, the second subcarrier sequence corresponding to each symbol is specifically calculated based on the interleaving parameters f₁, f₂, f₃, f₄ and fg, and thus whether the second subcarrier sequences corresponding to different symbols are the same or not is mainly related to whether the interleaving parameters used in calculating the second subcarrier sequences in different symbols are the same or not. When the interleaving parameters used in calculating the second subcarrier sequences in different symbols are different, the second subcarrier sequences corresponding to different symbols may be different, and when the interleaving parameters used in calculating the second subcarrier sequences in different symbols are the same, the second subcarrier sequences corresponding to the different symbols are the same.

Further, in the embodiment, a plurality of different groups of interleaving parameters are specifically determined and the plurality of different groups of interleaving parameters are applied to calculate the second subcarrier sequences corresponding to all symbols. As a result, there are at least two symbols in which different interleaving parameters are used to calculate the second subcarrier sequences, i.e., at least some of the symbols correspond to different second subcarrier sequences.

Further, when a plurality of groups of interleaving parameters are determined, as assigning to each symbol which group of interleaving parameters to calculate the corresponding second subcarrier sequence, it may be as follows.

in step a, a usage ratio corresponding to each group of interleaving parameters is determined firstly, in which the usage ration corresponding to each group of interleaving parameters is the same or different.

In an embodiment of the present disclosure, determining the usage ratio corresponding to each group of interleaving parameters includes at least one of:
determining the usage ratio corresponding to each group of interleaving parameters based on a protocol agreement;
determining the usage ratio corresponding to each group of interleaving parameters on its own;
determining the usage ratio corresponding to each group of interleaving parameters based on a configuration from a base station; and
determining the usage ratio corresponding to each group of interleaving parameters based on a configuration from a core network device.

For example, in an embodiment of the present disclosure, it is assumed that there are 2 groups of interleaving parameters, namely, interleaving parameter #1: f₁=@1, f₂=a₂, f₃=a₃, f₄=a₄ and f₅=a₅, and interleaving parameter #2: f₁=b₁, f₂=b₂, f₃=b₃, f₄=b₄ and f₅=b₅. The usage ratios of the interleaving parameter #1 and the interleaving parameter #2 may both be 50%, or the usage ratio of the interleaving parameter #1 is 30% and the usage ratio of the interleaving parameter #2 is 70%.

In step b, the second subcarrier index sequence corresponding to each symbol is calculated by taking the plurality of groups of the interleaving parameters into the 5-PP interleaver algebraic polynomial based on the usage ratio corresponding to each group of interleaving parameters.

Specifically, when calculating the second subcarrier index sequence corresponding to each symbol based on the usage ratio corresponding to each group of interleaving parameters, it may specifically satisfy the following: assuming that the second subcarrier index sequences in F symbols are calculated by using a certain group of interleaving parameters, F is equal to the product of the usage ratio of the group of interleaving parameters and the total number of symbols.

For example, it is assumed that the total number of symbols is 560, and it is determined that there are 2 groups of interleaving parameters, namely, interleaving parameter #1: f₁=@1, f₂=@2, 13=a₃, f₄=a₄ and f₅=a₅, and interleaving parameter #2: f₁=b₁, f₂=b₂, f₃=b₃, f₄=b₄ and f₅=b₅. In this case, the usage ratio of the interleaving parameter #1 is 30%, and the usage ratio of the interleaving parameter #2 is 70%. Then the second subcarrier sequences of any 560×30%=168 symbols among the 560 symbols may be calculated using the interleaving parameter #1, and the second subcarrier sequences of the remaining 560×70%=392 symbols among the 560 symbols may be calculated using the interleaving parameter #2.

In step 604c, the second subcarrier index sequence corresponding to each symbol is divided into K subcarrier groups, in which K is a number of sensing devices and is a positive integer, and each subcarrier group includes at least one subcarrier index.

In Step 605c, one subcarrier group is assigned to each of the K sensing devices in each symbol, in which a subcarrier corresponding to the subcarrier index in each subcarrier group is a frequency domain resource assigned to the sensing device.

In step 606c, frequency domain information is sent.

Other details about steps 601c-606c can refer to the above description of the embodiments, which will not be repeated herein in the embodiment of the present disclosure.

In view of the above, in the resource allocation method in the communication system provided in the embodiment of the present disclosure, the resource allocation scheme is first determined as performing the resource allocation based on the 5-PP interleaver, then the frequency domain resource is allocated based on the resource allocation scheme, and then the frequency domain information is sent, in which the frequency domain information is configured to determine the allocated frequency domain resource. As can be seen, in the embodiment of the present disclosure, the 5-PP interleaver is introduced to allocate resource for the sensing device, which avoids the allocation of consecutive subcarriers for the sensing device, reduces the correlation between the subcarriers of the sensing device, optimizes the frequency domain resource of the sensing and communication system, and thus improves the sensing detection resolution and performance of the sensing and communication system.

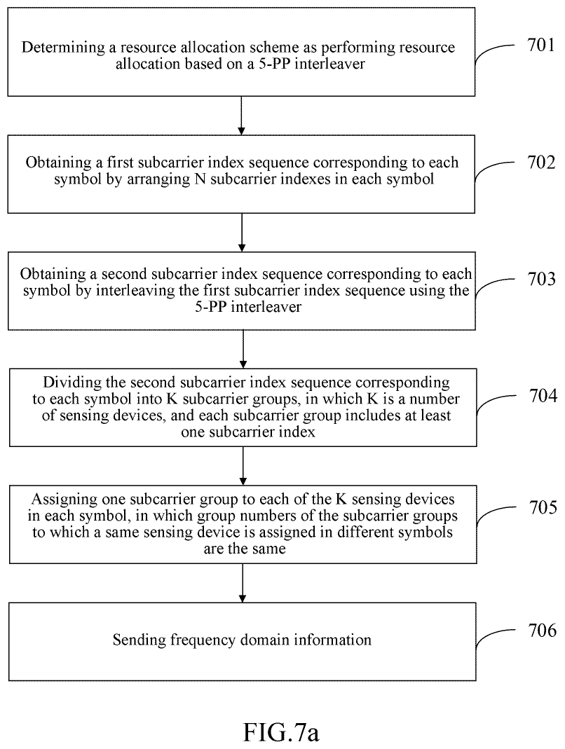

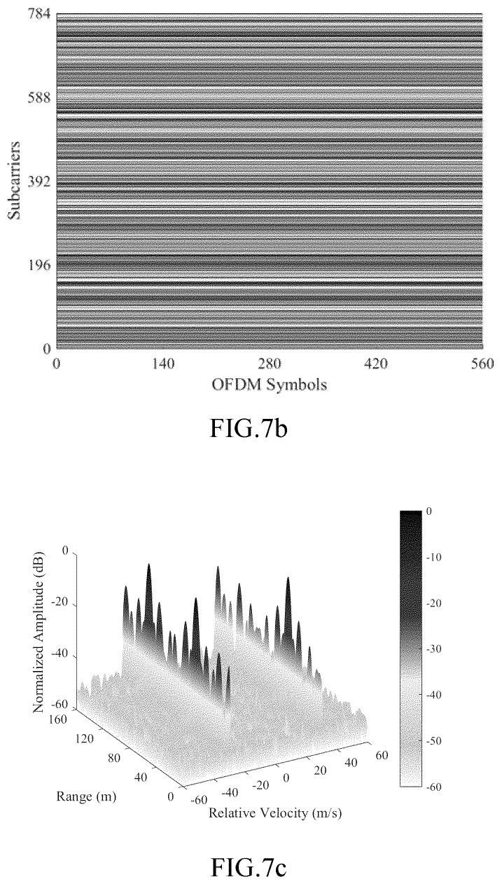

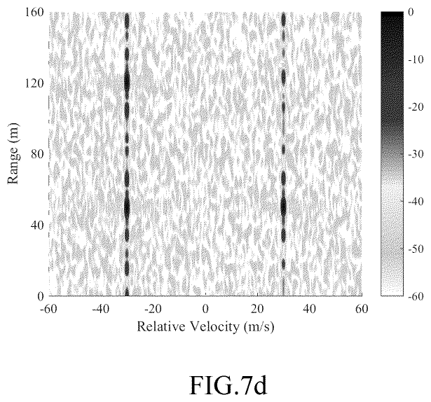

FIG. 7a is a flow diagram of a resource allocation method in a communication system provided in an embodiment of the present disclosure. As illustrated in FIG. 7a, the resource allocation method may include the following steps.

In step 701, a resource allocation scheme is determined as performing resource allocation based on a 5-PP interleaver.

In step 702, a first subcarrier index sequence corresponding to each symbol is obtained by arranging N subcarrier indexes in each symbol.

In step 703, a second subcarrier index sequence corresponding to each symbol is obtained by interleaving the first subcarrier index sequence using the 5-PP interleaver.

In step 704, the second subcarrier index sequence corresponding to each symbol is divided into K subcarrier groups, in which K is a number of sensing devices and is a positive integer, and each subcarrier group includes at least one subcarrier index.

In step 705, one subcarrier group is assigned to each of the K sensing devices in each symbol, and group numbers of the subcarrier groups to which a same sensing device is assigned in different symbols are the same.

For example, in an embodiment of the present disclosure, the subcarrier group #1 may be assigned to the sensing device-A in each symbol.

Further, in an embodiment of the present disclosure, it is assumed that the basic parameters of the sensing and communication system are illustrated in Table 1, and it is assumed that there are four UEs in the sensing and communication system, which respectively are a sensing device-A, a sensing device-B, a sensing device-C, and a sensing device-D, the range information and the velocity information of the four UEs are illustrated in Table 2.

TABLE 1
Basic parameters of the sensing and communication system

| Parameter name | Value | |
|---|---|---|
| Carrier frequency | 24 | GHz |
| Subcarrier spacing | 60 | kHz |
| Number of subcarriers | 784 | |
| Total symbol bandwidth | 47 | MHz |
| Number of OFDM symbols | 560 | |
| OFDM prefix duration | 1.17 | us |
| OFDM symbol duration | 16.67 | us |
| Full OFDM symbol duration | 17.84 | us |

TABLE 2
Velocity and range information of each sensing device

| Sensing device | Range (m) | Velocity (m/s) |
|---|---|---|
| A | 120 | −30 |
| B | 120 | 30 |
| C | 50 | −30 |
| D | 50 | 30 |

According to the basic parameters of the sensing and communication system in Table 1, it can be seen that the sensing device-A to the sensing device-D can each occupy 196 subcarriers of the 784 subcarriers, and the subcarrier indexes of the sensing device-A to the sensing device-D can be calculated by the 5-PP interleaver. FIG. 7b is a schematic diagram of the time-frequency resources of the sensing device-A when the resources are allocated using the method illustrated in FIG. 7a provided in an embodiment of the present disclosure, in which the white portion indicates the subcarriers occupied by the sensing device-A, and the black portion indicates the subcarriers not occupied by the sensing device-A. It can be seen from FIG. 7b that the allocation scheme is fixed in 560 OFDM symbols, i.e., the subcarrier indexes of the sensing device-A to the sensing device-D are constant in different OFDM symbols.

Further, it is to be noted that FIG. 7b is a schematic diagram obtained by taking the interleaving parameters f₁=199, f₂=7, f₃=560, f₄=777 and f₅=28 for calculating in the case of performing resource allocation based on the 5-PP interleaver function, and, FIGS. 7c and 7d are respectively a stereo view and a plan view of a radar detection for a sensing device with the method illustrated in FIG. 7a provided in an embodiment of the present disclosure, in which FIG. 7c is a stereo view of a radar detection, and FIG. 7d is a plan view of a radar detection. As can be seen from FIGS. 7c and 7d, although the side lobe is relatively obvious when detecting the sensing device, the range expansion on the range axis (i.e., the vertical axis) is suppressed, which optimizes the detection effect.

In step 706, frequency domain information is sent.

Other details about steps 701-706 can refer to the above description of the embodiments, which will not be repeated herein in the embodiment of the present disclosure.

In view of the above, in the resource allocation method in the communication system provided in the embodiment of the present disclosure, the resource allocation scheme is first determined as performing the resource allocation based on the 5-PP interleaver, then the frequency domain resource is allocated based on the resource allocation scheme, and then the frequency domain information is sent, in which the frequency domain information is configured to determine the allocated frequency domain resource. As can be seen, in the embodiment of the present disclosure, the 5-PP interleaver is introduced to allocate resource for the sensing device, which avoids the allocation of consecutive subcarriers for the sensing device, reduces the correlation between the subcarriers of the sensing device, optimizes the frequency domain resource of the sensing and communication system, and thus improves the sensing detection resolution and performance of the sensing and communication system.

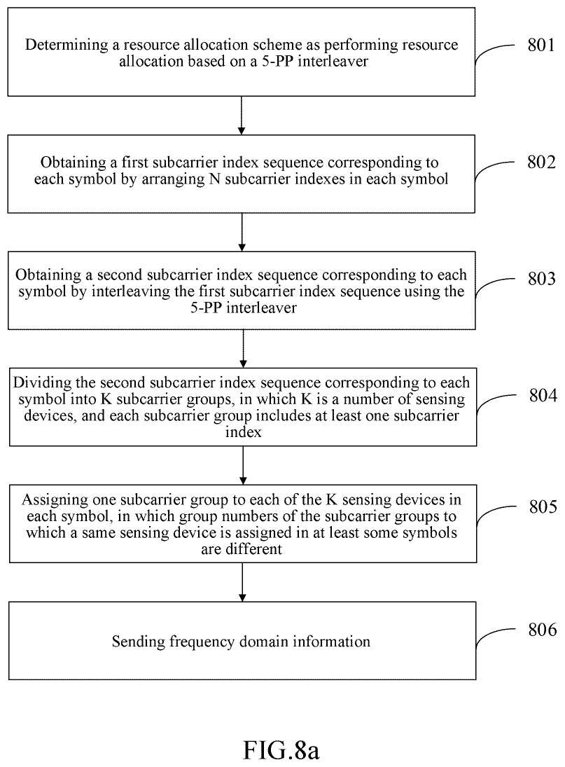

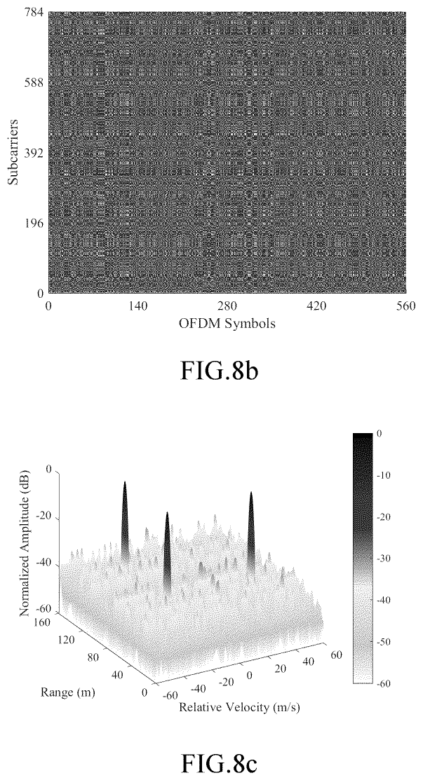

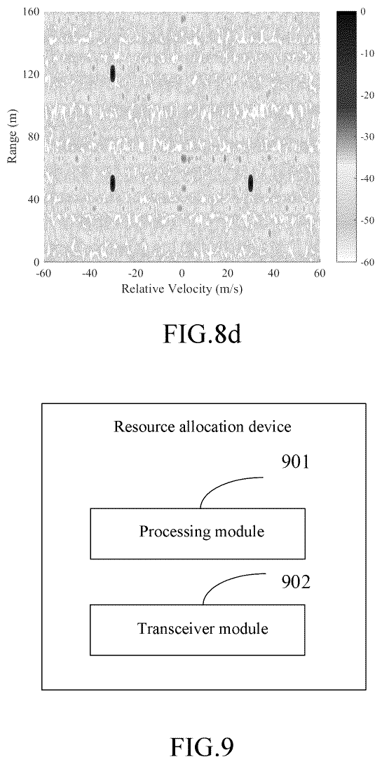

FIG. 8a is a flow diagram of a resource allocation method in a communication system provided in an embodiment of the present disclosure. As illustrated in FIG. 8a, the resource allocation method may include the following steps.

In step 801, a resource allocation scheme is determined as performing resource allocation based on a 5-PP interleaver.

In step 802, a first subcarrier index sequence corresponding to each symbol is obtained by arranging N subcarrier indexes in each symbol.

In step 803, a second subcarrier index sequence corresponding to each symbol is obtained by interleaving the first subcarrier index sequence using the 5-PP interleaver.

In step 804, the second subcarrier index sequence corresponding to each symbol is divided into K subcarrier groups, in which K is a number of sensing devices and is a positive integer, and each subcarrier group includes at least one subcarrier index.

In step 805, one subcarrier group is assigned to each of the K sensing devices in each symbol, and group numbers of the subcarrier groups to which a same sensing device is assigned in at least some symbols are different.

For example, in an embodiment of the present disclosure, the subcarrier group #1 may be assigned to the sensing device-A in a first symbol, the subcarrier group #2 may be assigned to the sensing device-A in a second symbol, and the subcarrier group #3 may be assigned to the sensing device-A in a third symbol.

Further, in an embodiment of the present disclosure, it is assumed that the basic parameters of the sensing and communication system are illustrated in Table 1, and it is assumed that there are four UEs in the sensing and communication system, which respectively are a sensing device-A, a sensing device-B, a sensing device-C, and a sensing device-D, the range information and the velocity information of the four UEs are illustrated in Table 2.

According to the basic parameters of the sensing and communication system in Table 1, it can be seen that the sensing device-A to the sensing device-D can each occupy 196 subcarriers of the 784 subcarriers, and the subcarrier indexes of the sensing device-A to the sensing device-D can be calculated by the 5-PP interleaver. FIG. 8b is a schematic diagram of the time-frequency resources of the sensing device-A when the resources are allocated using the method illustrated in FIG. 8a provided in an embodiment of the present disclosure, in which the white portion indicates the subcarriers occupied by the sensing device-A, and the black portion indicates the subcarriers not occupied by the sensing device-A. It can be seen from FIG. 8b that the allocation scheme varies randomly in 560 OFDM symbols, i.e., the subcarrier indexes of the sensing device-A to the sensing device-D vary randomly in different OFDM symbols.

Further, it is to be noted that FIG. 8b is a schematic diagram obtained by taking the interleaving parameters f₁=199, f₂=7, f₃=560, f₄=777 and f₅=28 for calculating in the case of performing resource allocation based on the 5-PP interleaver function, and, FIGS. 8c and 8d are respectively a stereo view and a plan view of a radar detection for a sensing device with the method illustrated in FIG. 8a provided in an embodiment of the present disclosure. As can be seen from FIGS. 8c and 8d, there are no obvious side peaks when detecting the sensing device, and the four sensing devices can be observed more clearly, therefore the detection effect is obviously superior.

In step 806, frequency domain information is sent.

Other details about steps 801-606 can refer to the above description of the embodiments, which will not be repeated herein in the embodiment of the present disclosure.

In view of the above, in the resource allocation method in the communication system provided in the embodiment of the present disclosure, the resource allocation scheme is first determined as performing the resource allocation based on the 5-PP interleaver, then the frequency domain resource is allocated based on the resource allocation scheme, and then the frequency domain information is sent, in which the frequency domain information is configured to determine the allocated frequency domain resource. As can be seen, in the embodiment of the present disclosure, the 5-PP interleaver is introduced to allocate resource for the sensing device, which avoids the allocation of consecutive subcarriers for the sensing device, reduces the correlation between the subcarriers of the sensing device, optimizes the frequency domain resource of the sensing and communication system, and thus improves the sensing detection resolution and performance of the sensing and communication system.

It is to be understood that although a specific number of user devices is described in the embodiment of the present disclosure, the number is merely exemplary, and the present disclosure does not limit the specific number of user devices.

In the followings, the subject matter by which the method can be performed is described with respect to the method application of FIGS. 5b to 8a described above (the followings are described by taking the sensing device as a UE as an example).

In an embodiment of the present disclosure, the method of FIGS. 5b to 8a described above may be performed by a base station alone. That is, the base station determines a resource allocation manner based on a 5-PP interleaver and configures the same to a UE. The UE performs the resource transfer based on the configuration of the base station. Specifically, the base station determines a resource allocation scheme as performing resource allocation based on a 5-PP interleaver (in which the method of determining the resource allocation scheme by the base station may be referred to the methods a to d in step 501), then the base station allocates a frequency domain resource based on the determined resource allocation scheme and sends frequency domain information for determining the allocated resource to the sensing device, so that the sensing device determines, based on the frequency domain information, the frequency domain resource allocated thereto. Further, it is to be noted that in an embodiment of the present disclosure, the base station, after determining the resource allocation scheme, may also send the resource allocation scheme determined by the base station to the UE, so that the UE may determine, based on the resource allocation scheme, the frequency domain resource allocated thereto.

In another embodiment of the present disclosure, the methods of FIGS. 5 to 8a described above may be performed by both the base station and the UE. Specifically, both the base station and the UE may first determine a resource allocation scheme as performing resource allocation based on a 5-PP interleaver, and allocate a frequency domain resource based on the resource allocation scheme. The method of determining the resource allocation scheme by the UE may refer to the methods a to c in step 501.

In yet another embodiment of the present disclosure, the methods of FIGS. 5 to 8a described above may be performed by another base station. Specifically, another base station first determines a resource allocation scheme as performing resource allocation based on a 5-PP interleaver, and allocates a frequency domain resource based on the resource allocation scheme, and then sends frequency domain information to a base station and a UE in the sensing and communication system respectively, in order to cause both the base station and the UE to determine the frequency domain resource allocated for the sensing device.

FIG. 9 is a schematic diagram of a structure of a resource allocation device in a communication system provided in an embodiment of the present disclosure. As illustrated in FIG. 9, the device includes a processing module and a transceiver module.

The processing module is configured to determine a resource allocation scheme as performing resource allocation based on a 5-PP interleaver.

The processing module is further configured to allocate a frequency domain resource based on the resource allocation scheme.

The transceiver module is configured to send frequency domain information, the frequency domain information being configured to determine an allocated frequency domain resource.

In view of the above, in the resource allocation device in the communication system provided in the embodiment of the present disclosure, the resource allocation scheme is first determined as performing the resource allocation based on the 5-PP interleaver, then the frequency domain resource is allocated based on the resource allocation scheme, and then the frequency domain information is sent, in which the frequency domain information is configured to determine the allocated frequency domain resource. As can be seen, in the embodiment of the present disclosure, the 5-PP interleaver is introduced to allocate resource for the sensing device, which avoids the allocation of consecutive subcarriers for the sensing device, reduces the correlation between the subcarriers of the sensing device, optimizes the frequency domain resource of the sensing and communication system, and thus improves the sensing detection resolution and performance of the sensing and communication system.

In an embodiment of the present disclosure, the processing module is further configured to:
obtain a first subcarrier index sequence corresponding to each symbol by arranging N subcarrier indexes in each symbol;
obtain a second subcarrier index sequence corresponding to each symbol by interleaving the first subcarrier index sequence using the 5-PP interleaver;
divide the second subcarrier index sequence corresponding to each symbol into K subcarrier groups, wherein K is a number of sensing devices and is a positive integer, and each subcarrier group includes at least one subcarrier index; and
assign one subcarrier group to each of the K sensing devices in each symbol, wherein a subcarrier corresponding to the subcarrier index in each subcarrier group is a frequency domain resource assigned to the sensing device.

In an embodiment of the present disclosure, the device is further configured to:
determine parameter information of the 5-PP interleaver,
wherein the parameter information of the 5-PP interleaver includes at least one of:
a 5-PP interleaver algebraic polynomial;
a decomposition formula corresponding to the 5-PP interleaver; and
a parameter value-determining rule in the 5-PP interleaver algebraic polynomial.

In an embodiment of the present disclosure, the 5-PP interleaver algebraic polynomial is:

$$π ( i ) = ( {f}_{1} \cdot i + {f}_{2} \cdot {i}^{2} + {f}_{3} \cdot {i}^{3} + {f}_{4} \cdot {i}^{4} + {f}_{5} \cdot {i}^{5} ) mod N \qquad ( 1 )$$

wherein i is configured to indicate an i^{th} index in the second subcarrier index sequence, π(i) is a value of the i^{th} index in the second subcarrier index sequence, and f₁, f₂, f₃, f₄ and f₅ are five interleaving parameters of the 5-PP interleaver, and wherein the parameter value-determining rule is configured to determine values of the interleaving parameters f₁, f₂, f₃, f₄ and f₅.

In an embodiment of the present disclosure, the decomposition formula corresponding to the 5-PP interleaver is:

$$N = {\prod }_{i = 1}^{ω ( N )} {p}_{i}^{{α}_{N , i}} \qquad ( 2 )$$

wherein Ω(N) is a positive integer, pᵢ is a factor of N, and α_{N,i} is a corresponding exponent.

In an embodiment of the present disclosure, the parameter value-determining rule is:

| | | |
|---|---|---|
| P₁ = 2 | α_{N, 1} = 1 | (f₁ + f₂ + f₃ + f₄ + f₅) = 1mod2 |
| | α_{N, 1} > 1 | f₁ = 1mod2, (f₂ + f₄) = 0mod2, (f₃ + f₅) = 0mod2 |
| P₂ = 3 | α_{N, 2} = 1 | (f₁ + f₃ + f₅) ≠ 0mod3, (f₂ + f₄) = 0mod3 |
| | α_{N, 2} > 1 | f₁ ≠ 0mod3, (f₁ + f₃ + f₅) ≠ 0mod3, |
| | | (f₂ + f₄) = 0mod3, |
| | | (f₁ + f₂ + 2f₅) ≠ 0mod3, (f₁ + f₄ + 2f₅) ≠ 0mod3. |

In an embodiment of the present disclosure, obtaining the second subcarrier index sequence corresponding to each symbol by interleaving the first subcarrier index sequence using the 5-PP interleaver includes:
determining values of pᵢ and α_{N,i} by decomposing the N based on the decomposition formula;
determining the values of the interleaving parameters f₁, f₂, f₃, f₄ and f₅ based on the values of pᵢ and α_{N,i} and the parameter value-determining rule; and
calculating the second subcarrier index sequence corresponding to each symbol by taking the interleaving parameters into the 5-PP interleaver algebraic polynomial.

In an embodiment of the present disclosure, the values of the interleaving parameters determined based on the values of pᵢ and α_{N,i} and the parameter value-determining rule are divided into a plurality of groups, and the interleaving parameters are not the same in the plurality of groups,
calculating the second subcarrier index sequence corresponding to each symbol by taking the interleaving parameters into the 5-PP interleaver algebraic polynomial includes:
determining a usage ratio corresponding to each group of interleaving parameters, wherein the usage ration corresponding to each group of interleaving parameters is the same or different; and
calculating the second subcarrier index sequence corresponding to each symbol by taking the plurality of groups of the interleaving parameters into the 5-PP interleaver algebraic polynomial based on the usage ratio corresponding to each group of interleaving parameters.

In an embodiment of the present disclosure, the K subcarrier groups satisfy the following condition:
in response to that N is divisible by K, a number of subcarrier indexes in each of the K subcarrier groups is the same; and
in response to that N is not divisible by K, a number of subcarrier indexes in each of d subcarrier groups among the K subcarrier groups is the same, a number of subcarrier indexes in each of other subcarrier groups than the d subcarrier groups among the K subcarrier groups is the same, and the number of subcarrier indexes in each of the d subcarrier groups is 1 more than the number of subcarrier indexes in each of the other subcarrier groups, wherein d is a value obtained by N mod K.

In an embodiment of the present disclosure, group numbers of the subcarrier groups to which a same sensing device is assigned in different symbols are the same or different.

In an embodiment of the present disclosure, the transceiver module is further configured to:
determine the resource allocation scheme based on a protocol agreement;
determine the resource allocation scheme on its own;
determine the resource allocation scheme based on a configuration from a base station;
determine the resource allocation scheme based on a configuration from a core network device.

In an embodiment of the present disclosure, the device is further configured:
obtain the parameter information of the 5-PP interleaver sent by a base station, wherein the parameter information of the 5-PP interleaver is pre-configured to the base station by a core network device;
obtain the parameter information of the 5-PP interleaver sent by the base station, wherein the parameter information of the 5-PP interleaver is pre-configured to the base station by another base station;
obtain the parameter information of the 5-PP interleaver sent by a network device;
determine the parameter information of the 5-PP interleaver based on a protocol agreement.

In an embodiment of the present disclosure, the device is further configured to:
determine the usage ratio corresponding to each group of interleaving parameters based on a protocol agreement;
determine the usage ratio corresponding to each group of interleaving parameters on its own;
determine the usage ratio corresponding to each group of interleaving parameters based on a configuration from a base station;
determine the usage ratio corresponding to each group of interleaving parameters based on a configuration from a core network device.

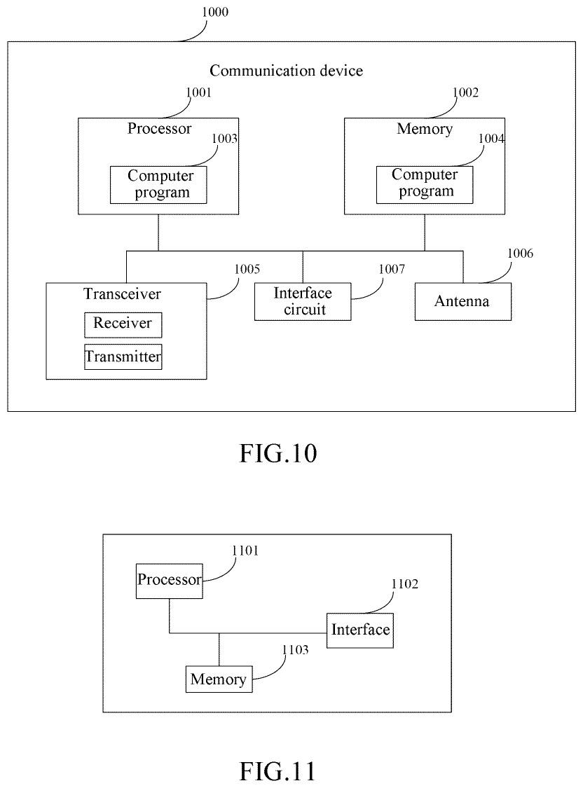

Referring to FIG. 10, FIG. 10 is a schematic diagram of a structure of a communication device 1000 provided in an embodiment of the present disclosure. The communication device 1000 may be a network device, or may be a terminal device, or may be a chip, a chip system, a processor, or the like that supports the network device to implement the above-described method, or may be a chip, a chip system, a processor or the like that supports the terminal device to implement the above-described method. The device may be configured to implement the method described in the above method embodiment, which may refer to the description in the above method embodiment.

The communication device 1000 may include one or more processors 1001. The processor 1001 may be a general purpose processor, a dedicated processor, or the like. For example, it may be a baseband processor or a central processor. The baseband processor may be used for processing communication protocols as well as communication data, and the central processor may be used for controlling a communication device (e.g., a base station, a baseband chip, a terminal device, a terminal device chip, a DU, a CU or the like) to execute a computer program and process data of the computer program.

In an embodiment of the present disclosure, the communication device 1000 may further include one or more memories 1002 on which a computer program 1004 may be stored, and the processor 1001 executes the computer program 1004 to cause the communication device 1000 to perform the method described in the above method embodiment. In an embodiment of the present disclosure, data may also be stored in the memory 1002. The communication device 1000 and the memory 1002 may be provided separately or may be integrated together.

In an embodiment of the present disclosure, the communication device 1000 may further include a transceiver 1005, and an antenna 1006. The transceiver 1005 may be referred to as a transceiver unit, a transceiver machine, a transceiver circuit, or the like for implementing transceiver function. The transceiver 1005 may include a receiver and a transmitter, the receiver may be referred to as a receiver machine, a receiving circuit, or the like for implementing receiving function, and the transmitter may be referred to as a transmitter machine, a transmitting circuit, or the like for implementing transmitting function.

In an embodiment of the present disclosure, one or more interface circuits 1007 may also be included in the communication device 1000. The interface circuit 1007 is used for receiving code instructions and transmitting the same to the processor 1001. The processor 1001 runs the code instructions to cause the communication device 1000 to perform the method described in the above method embodiment.

In an implementation, the processor 1001 may include a transceiver for implementing receiving and transmitting functions. The transceiver may for example be a transceiver circuit, or an interface, or an interface circuit. The transceiver circuit, interface, or interface circuit for implementing the receiving and transmitting functions may be separate or may be integrated together. The transceiver circuit, interface, or interface circuit described above may be used for code/data reading and writing, or the transceiver circuit, interface, or interface circuit described above may be used for signal transmission or delivery.

In an implementation, the processor 1001 may store a computer program 1003 which, when running on the processor 1001, may cause the communication device 1000 to perform the method described in the above method embodiment. The computer program 1003 may be solidified in the processor 1001, in which case the processor 1001 may be implemented by hardware.

In an implementation, the communication device 1000 may include a circuit, and the circuit may implement the transmitting or receiving or communicating function in the above method embodiment. The processor and the transceiver described in the present disclosure may be implemented in integrated circuit (IC), analogue IC, radio frequency integrated circuit (RFIC), mixed signal IC, application specific integrated circuit (ASIC), printed circuit board (PCB), electronic device, or the like. The processor and the transceiver may also be fabricated using various IC process technologies such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon-germanium (SiGe), gallium arsenide (GaAs) and so on.

The communication device described in the above embodiments may be a network device or a terminal device, but the scope of the communication device described in the present disclosure is not limited thereto, and the structure of the communication device may not be limited by FIG. 10. The communication device may be a stand-alone device or may be part of a larger device. For example, the communication device may be:
(1) a stand-alone integrated circuit IC, or chip, or chip system or subsystem;
(2) a collection having one or more ICs, in an embodiment of the present disclosure, the IC collection may also include a storage component for storing data, computer program;
(3) an ASIC, such as a modem;
(4) a module that can be embedded within another device;
(5) a receiver, terminal device, smart terminal device, cellular phone, wireless device, handheld set, mobile unit, in-vehicle device, network device, cloud device, artificial intelligence device, and the like; and
(6) others.

For the case where the communication device may be a chip or a chip system, it may refer to the schematic diagram of the structure of the chip illustrated in FIG. 11. The chip illustrated in FIG. 11 includes a processor 1101 and an interface 1102. The number of processors 1101 may be one or more, and the number of interfaces 1102 may be more than one.

In an embodiment of the present disclosure, the chip also includes a memory 1103, and the memory 1103 is used to store necessary computer programs and data.

It is also to be appreciated by a person in the art that the various illustrative logical blocks and steps listed in the embodiment of the present disclosure may be implemented by an electronic hardware, a computer software, or a combination thereof. Whether such function is implemented by hardware or software depends on the particular application and the design requirements of the overall system. For each particular application, a person skilled in the art may may use various methods to implement the described function, but such implementation should not be construed as being outside the protection scope of the embodiment of the present disclosure.

The present disclosure also provides a readable storage medium having stored thereon instructions which, when being executed by a computer, implement the function of any of the method embodiments described above.

The present disclosure also provides a computer program product, which when being executed by a computer, realizes the function of any of the above method embodiments.

The above embodiment may be achieved in whole or in part by software, hardware, firmware, or any combination thereof. When being implemented using software, it may be implemented in whole or in part in the form of a computer program product. The computer program product includes one or more computer programs. When the computer program is loaded and executed on a computer produces, a process or function according to the embodiment of the present disclosure is generated in whole or in part. The computer may be a general purpose computer, a special purpose computer, a computer network, or other programmable device. The computer program may be stored in a computer-readable storage medium or transmitted from one computer-readable storage medium to another computer-readable storage medium, for example, the computer program may be transmitted from a web site, computer, server, or data center to another web site, computer, server or data center via a wired (e.g., coaxial cable, fiber optic, digital subscriber line (DSL)) or wireless (e.g. infrared, wireless, microwave, etc.) manner. The computer-readable storage medium may be any usable medium to which a computer can access or a data storage device such as a server, data center containing one or more usable media integrated. The usable medium may be a magnetic medium (e.g., floppy disk, hard disk, magnetic tape), an optical medium (e.g., a high-density digital video disc (DVD)), a semiconductor medium (e.g., a solid state disk (SSD)), or the like.

A person skilled in the art may understand that the first, second and other numerical numbers involved in the present disclosure are only for distinguishing for the convenience of description, and are used to neither limit the scope of the embodiments of the present disclosure nor indicate the precedence order.

The “at least one” in the present disclosure may also be described as one or more, and the “plurality” may be two, three, four, or more, which is not limited in the present disclosure. In the embodiment of the present disclosure, for one kind of technical features, the technical features in such kind of the technical features are distinguished by “first”, “second”, “third”, “A”, “B”, “C”, “D” or the like, and there is no order of precedence or order of magnitude among the technical features described by the “first”, “second”, “third”, “A”, “B”, “C”, “D” or the like.

The correspondence illustrated in each table in the present disclosure may be configured or predefined. The values of the information in the table are only examples, and can be configured to be other values, which is not limited in the present disclosure. In configuring the correspondence between the information and the respective parameters, it is not necessarily required that all correspondences illustrated in the respective tables must be configured. For example, the correspondences illustrated in certain rows of the table in the present disclosure may also not be configured. For another example, it is possible to make appropriate adjustments on the basis of the above tables such as splitting, merging, or the like. The names of the parameters illustrated in the headings in the above tables may also be other names understandable by the communication device, and the values or representations of the parameters thereof may also be other values or representations understandable by the communication device. Each of the above tables may also be implemented using other data structures, for example, an array, a queue, a container, a stack, a linear table, a pointer, a linked list, a tree, a graph, a structure, a class, a heap, a hash table or the like may be used.

“Predefined” in the present disclosure may be understood as defined, pre-defined, stored, pre-stored, pre-negotiated, pre-configured, cured, or pre-fired.

A person skilled in the art may realize that the units and algorithmic steps of the various examples described in conjunction with the embodiments disclosed herein are capable of being implemented in electronic hardware or a combination of computer software and electronic hardware. Whether these functions are performed in hardware or software depends on the particular application and design constraints of the technical solution. A person skilled in the art may use different methods to implement the described functions for each particular application, but such implementation should not be considered outside the scope of the present disclosure.

It is clear to a person skilled in the art that, for the convenience and brevity of the description, the specific working processes of the above-described system, device and unit can be referred to the corresponding processes in the foregoing method embodiments which will not be repeated herein.

The above description is only an implementation of the present disclosure, but the protection scope of the present disclosure is not limited thereto, and any person skilled in the art may easily conceive of changes or substitutions within the disclosed technique scope of the present disclosure, which all are within the protection scope of the present disclosure. Therefore, the protection scope of the present disclosure shall be subject to the protection scope of the claims.

1. A resource allocation method in a communication system, comprising:
determining a resource allocation scheme, the resource allocation scheme being performing resource allocation based on a quintic permutation polynomial (5-PP) interleaver;
allocating a frequency domain resource based on the resource allocation scheme; and
sending frequency domain information, the frequency domain information being configured to determine the allocated frequency domain resource.

2. The method according to claim 1, wherein allocating the frequency domain resource according to the resource allocation scheme comprises:
obtaining a first subcarrier index sequence corresponding to each symbol by arranging N subcarrier indexes in each symbol;
obtaining a second subcarrier index sequence corresponding to each symbol by interleaving the first subcarrier index sequence using the 5-PP interleaver;
dividing the second subcarrier index sequence corresponding to each symbol into K subcarrier groups, wherein K is a number of sensing devices and is a positive integer, and each subcarrier group comprises at least one subcarrier index; and
assigning one subcarrier group to each of the K sensing devices in each symbol, wherein a subcarrier corresponding to the subcarrier index in each subcarrier group is a frequency domain resource assigned to the sensing device.

3. The method according to claim 2, further comprising:
determining parameter information of the 5-PP interleaver,
wherein the parameter information of the 5-PP interleaver comprises at least one of:
a 5-PP interleaver algebraic polynomial;
a decomposition formula corresponding to the 5-PP interleaver; or
a parameter value-determining rule in the 5-PP interleaver algebraic polynomial.

4. The method according to claim 3, wherein the 5-PP interleaver algebraic polynomial is:
$$π ( i ) = ( {f}_{1} \cdot i + {f}_{2} \cdot {i}^{2} + {f}_{3} \cdot {i}^{3} + {f}_{4} \cdot {i}^{4} + {f}_{5} \cdot {i}^{5} ) mod N \underline{,} \qquad [ [ ( 1 ) ] ]$$
wherein i is configured to indicate an i^{th} index in the second subcarrier index sequence, π(i) is a value of the i^{th} index in the second subcarrier index sequence, and f₁, f₂, f₃, f₄ and f₅ are five interleaving parameters of the 5-PP interleaver, and wherein the parameter value-determining rule is configured to determine values of the interleaving parameters f₁, f₂, f₃, f₄ and f₅.

5. The method according to claim 3, wherein the decomposition formula corresponding to the 5-PP interleaver is:
$$N = {\prod }_{i = 1}^{ω ( N )} {p}_{i}^{{α}_{N , i}} \underline{,} \qquad [ [ ( 2 ) ] ]$$
wherein Ω(N) is a positive integer, pᵢ is a factor of N, and α_{N,i} is a corresponding exponent.

6. The method according to claim 3, wherein the parameter value-determining rule is:

| | | |
|---|---|---|
| P₁ = 2 | α_{N, 1} = 1 | (f₁ + f₂ + f₃ + f₄ + f₅) = 1mod2 |
| | α_{N, 1} > 1 | f₁ = 1mod2, (f₂ + f₄) = 0mod2, (f₃ + f₅) = 0mod2 |
| P₂ = 3 | α_{N, 2} = 1 | (f₁ + f₃ + f₅) ≠ 0mod3, (f₂ + f₄) = 0mod3 |
| | α_{N, 2} > 1 | f₁ ≠ 0mod3, (f₁ + f₃ + f₅) ≠ 0mod3, |
| | | (f₂ + f₄) = 0mod3, |
| | | (f₁ + f₂ + 2f₅) ≠ 0mod3, (f₁ + f₄ + 2f₅) ≠ 0mod3. |

7. The method according to claim 6, wherein obtaining the second subcarrier index sequence corresponding to each symbol by interleaving the first subcarrier index sequence using the 5-PP interleaver comprises:
determining values of pᵢ and α_{N,i} by decomposing the N based on the decomposition formula;
determining the values of the interleaving parameters f₁, f₂, f₃, f₄ and f₅ based on the values of pᵢ and α_{N,i} and the parameter value-determining rule; and
calculating the second subcarrier index sequence corresponding to each symbol by taking the interleaving parameters into the 5-PP interleaver algebraic polynomial.

8. The method according to claim 7, wherein the values of the interleaving parameters determined based on the values of pᵢ and α_{N,i} and the parameter value-determining rule are divided into a plurality of groups, and the interleaving parameters are not the same in the plurality of groups,
calculating the second subcarrier index sequence corresponding to each symbol by taking the interleaving parameters into the 5-PP interleaver algebraic polynomial comprises:
determining a usage ratio corresponding to each group of interleaving parameters, wherein the usage ration corresponding to each group of interleaving parameters is the same or different; and
calculating the second subcarrier index sequence corresponding to each symbol by taking the plurality of groups of the interleaving parameters into the 5-PP interleaver algebraic polynomial based on the usage ratio corresponding to each group of interleaving parameters.

9. The method according to claim 2, wherein the K subcarrier groups satisfy the following condition:
in response to that N is divisible by K, a number of subcarrier indexes in each of the K subcarrier groups is the same; and
in response to that N is not divisible by K, a number of subcarrier indexes in each of d subcarrier groups among the K subcarrier groups is the same, a number of subcarrier indexes in each of other subcarrier groups than the d subcarrier groups among the K subcarrier groups is the same, and the number of subcarrier indexes in each of the d subcarrier groups is 1 more than the number of subcarrier indexes in each of the other subcarrier groups, wherein d is a value obtained by N mod K.

10. The method according to claim 2, wherein group numbers of the subcarrier groups to which a same sensing device is assigned in different symbols are the same or different.

11. The method according to claim 1, wherein determining the resource allocation scheme comprises at least one of:
determining the resource allocation scheme based on a protocol agreement;
determining the resource allocation scheme on its own;
determining the resource allocation scheme based on a configuration from a base station; or
determining the resource allocation scheme based on a configuration from a core network device.

12. The method according to claim 3, wherein determining the parameter information of the 5-PP interleaver comprises at least one of:
obtaining the parameter information of the 5-PP interleaver sent by a base station, wherein the parameter information of the 5-PP interleaver is pre-configured to the base station by a core network device;
obtaining the parameter information of the 5-PP interleaver sent by the base station, wherein the parameter information of the 5-PP interleaver is pre-configured to the base station by another base station;
obtaining the parameter information of the 5-PP interleaver sent by a network device; or
determining the parameter information of the 5-PP interleaver based on a protocol agreement.

13. The method according to claim 8, wherein determining the usage ratio corresponding to each group of interleaving parameters comprises at least one of:
determining the usage ratio corresponding to each group of interleaving parameters based on a protocol agreement;
determining the usage ratio corresponding to each group of interleaving parameters on its own;
determining the usage ratio corresponding to each group of interleaving parameters based on a configuration from a base station; or
determining the usage ratio corresponding to each group of interleaving parameters based on a configuration from a core network device.

14. (canceled)

15. A communication device, comprising:
a processor; and
a memory storing a computer program executable by the processor,
wherein the processor is configured to:
determine a resource allocation scheme, the resource allocation scheme being performing resource allocation based on a quintic permutation polynomial (5-PP) interleaver;
allocate a frequency domain resource based on the resource allocation scheme; and
send frequency domain information, the frequency domain information being configured to determine the allocated frequency domain resource.

16. (canceled)

17. A non-transitory computer readable storage medium having stored thereon instructions that, when being executed by a processor, cause the processor to perform a resource allocation method in a communication system, the resource allocation method comprising:
determining a resource allocation scheme, the resource allocation scheme being performing resource allocation based on a quintic permutation polynomial (5-PP) interleaver;
allocating a frequency domain resource based on the resource allocation scheme; and
sending frequency domain information, the frequency domain information being configured to determine the allocated frequency domain resource.

18. The communication device according to claim 15, wherein the processor is configured to:
obtain a first subcarrier index sequence corresponding to each symbol by arranging N subcarrier indexes in each symbol;
obtain a second subcarrier index sequence corresponding to each symbol by interleaving the first subcarrier index sequence using the 5-PP interleaver;
divide the second subcarrier index sequence corresponding to each symbol into K subcarrier groups, wherein K is a number of sensing devices and is a positive integer, and each subcarrier group comprises at least one subcarrier index; and
assign one subcarrier group to each of the K sensing devices in each symbol, wherein a subcarrier corresponding to the subcarrier index in each subcarrier group is a frequency domain resource assigned to the sensing device.

19. The communication device according to claim 18, wherein the processor is further configured to:
determine parameter information of the 5-PP interleaver,
wherein the parameter information of the 5-PP interleaver comprises at least one of:
a 5-PP interleaver algebraic polynomial;
a decomposition formula corresponding to the 5-PP interleaver; or
a parameter value-determining rule in the 5-PP interleaver algebraic polynomial.

20. The communication device according to claim 19, wherein the 5-PP interleaver algebraic polynomial is:
$$π ( i ) = ( {f}_{1} \cdot i + {f}_{2} \cdot {i}^{2} + {f}_{3} \cdot {i}^{3} + {f}_{4} \cdot {i}^{4} + {f}_{5} \cdot {i}^{5} ) mod N ,$$
wherein i is configured to indicate an i^{th} index in the second subcarrier index sequence, π(i) is a value of the i^{th} index in the second subcarrier index sequence, and f₁, f₂, f₃, f₄ and f₅ are five interleaving parameters of the 5-PP interleaver, and wherein the parameter value-determining rule is configured to determine values of the interleaving parameters f₁, f₂, f₃, f₄ and f₅.

21. The communication device according to claim 19, wherein the decomposition formula corresponding to the 5-PP interleaver is:
$$N = {\prod }_{i = 1}^{ω ( N )} {p}_{i}^{{α}_{N , i}} ,$$
wherein Ω(N) is a positive integer, pᵢ is a factor of N, and α_{N,i} is a corresponding exponent.

22. The communication device according to claim 19, wherein the parameter value-determining rule is:

| | | |
|---|---|---|
| P₁ = 2 | α_{N, 1} = 1 | (f₁ + f₂ + f₃ + f₄ + f₅) = 1mod2 |
| | α_{N, 1} > 1 | f₁ = 1mod2, (f₂ + f₄) = 0mod2, (f₃ + f₅) = 0mod2 |
| P₂ = 3 | α_{N, 2} = 1 | (f₁ + f₃ + f₅) ≠ 0mod3, (f₂ + f₄) = 0mod3 |
| | α_{N, 2} > 1 | f₁ ≠ 0mod3, (f₁ + f₃ + f₅) ≠ 0mod3, |
| | | (f₂ + f₄) = 0mod3, |
| | | (f₁ + f₂ + 2f₅) ≠ 0mod3, (f₁ + f₄ + 2f₅) ≠ 0mod3. |
